(19) United States
(12) Patent Application Publication
(10) Pub. No.: US 2026/0065287 A1
(43) Pub. Date: Mar. 5, 2026

(54) SYSTEM AND METHOD FOR USE WITH A DATA ANALYTICS ENVIRONMENT TO ENABLE USE OF AI IN PROVIDING CUSTOMER SUPPORT

(71) Applicant: ORACLE INTERNATIONAL CORPORATION, Redwood Shores, CA (US)

(72) Inventor: Uma Nagarajan, Bengaluru (IN)

(21) Appl. No.: 19/258,192

(22) Filed: Jul. 2, 2025

Related U.S. Application Data
(60) Provisional application No. 63/690,569, filed on Sep. 4, 2024.

(51) Int. Cl. G06Q 30/015

(52) U.S. Cl. CPC G06Q 30/015

(57) ABSTRACT

Embodiments described herein are generally related to data analytics environments, and are particularly directed to systems and methods for use with a data analytics environment to enable use of AI in providing customer support. Machine learning AI models are trained based on one or more previous service request lifecycles of service requests of a customer to determine latent emotions of the customer based on determined customer problem data. A customer service prioritization signal related to a current service request of the customer is generated by a predictive analytics application that includes the models. The customer service prioritization signal is indicative of a need to prioritize a current service request of the customer based on the determined latent emotions of the customer and is generated during and prior to the end of the lifecycle of the current service request whereby escalation of the current service request may be deferred or prevented.

### CLAIM OF PRIORITY AND CROSS-REFERENCE TO RELATED APPLICATIONS

This application claims the benefit of priority to U.S. Provisional Patent Application titled “SYSTEM AND METHOD FOR USE WITH A DATA ANALYTICS ENVIRONMENT TO ENABLE USE OF AI IN PROVIDING CUSTOMER SUPPORT”, Application No. 63/690,569, filed Sep. 4, 2024; which above application and the contents thereof is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to data analytics environments, and are particularly directed to systems and methods for use with a data analytics environment to enable use of AI in providing customer support.

### BACKGROUND

Generally described, data analytics enables the computer-based examination of an amount of data, to derive an analytic data, metrics, conclusions, or other types of analytical information from, or descriptive of, the source data. Systems and methods can be used, for example, to generate an analytic business intelligence data, such as a set of data metrics or measures operating as key performance indicators, which analytically describe an organization's business-related data in a format useful to its decision-makers.

Customer support has evolved a great deal in the last decade. It has shifted recently from being a cost center to becoming a revenue center. Customer support is becoming a point of discussion and a key differentiator in the agreement stage in negotiations with prospective users such as prospective software users for example. Criticality and urgency relative to support for software uses is the norm. A full and complete uptime twenty fours a day and seven days per week is an expectation and not an exception. Customers want faster resolutions, and that time factor only gets shorter and more compressed.

A question for any organization may be whether their contact center lives up to the expectations of the software users or customers. This is generally not the case because research suggests customer escalation increases exponentially, and organizations spend millions of dollars annually. It does not end here, wherein if escalations of software users or customers are not handled well, an organization may lose not just its present customers but future customers as they may be making decisions based on support and service rather than putting the decision on purchases, upgrades and the like on price, function, or feature.

Much research shows that customer effort equates to loyalty. The more effortless the support experience is to a customer, the more loyal the customer will be to the brand. Hence, there is a switch in the industry from focusing on customer satisfaction to focusing on customer effort score (CES). This being the case, for customers to see more value in a service, seller or provider organizations need to prevent/deflect of support request escalations, improve contact center efficiency, and provide an effortless experience (high CES), which will help with a high customer retention rate and avoid lost revenue. Handling the underlying support ticket after an escalation occurs is very expensive for organizations, amounting to millions of dollars annually. Furthermore, software defect escalations can, if not handled properly, result in a loss of reputation, satisfaction, loyalty, and customers.

Sentiment analysis has been used by various entities in the market for determining customer satisfaction. However, on most occasions, the customers are already frustrated by the time they reach support. There is a need in the art, therefore, for systems, methods, and computer readable medium storing programs that when executed enable use of AI in providing customer support wherein end user customer support request escalations may be preemptively addressed and/or deflected before exceeding a determined threshold.

### SUMMARY

Embodiments described herein are generally related to data analytics environments, and are particularly directed to systems and methods for use with a data analytics environment to enable use of AI in providing customer support.

Embodiments described herein capture emotions on all the customer touch points during the lifecycle of a request for support or a support request “ticket,” and uses them to reflect the current trend itself, wherein the reflected current trend may be a CES trend.

In the example embodiments herein, multiple and preferably all the touch points of a support request model across the lifecycle of a request for support or a support request ticket are mapped to customer emotions and points of “pain,” “comfort,” satisfaction, “agitation,” and the like. These mappings are translated to problems in descriptive analytics language and fed as input to one or more machine learning models. The one or more machine learning models are trained with the problems of every touch point thereby enabling the one or more machine learning models to preemptively flag or otherwise identify all tickets that need immediate attention before they snowball into escalations or can potentially affect the CES. A proactive escalation management dashboard of the example embodiments herein will have these predictions that can be used for smart prioritization or to trigger workflows that can initiate an action item to the customer support agent.

In accordance with an aspect, a system is provided for use with a data analytics environment to enable use of artificial intelligence (AI) in providing customer support.

The system includes a computer that includes one or more processors and that provides access to the data analytics environment, a data store application running at the data analytic environment, a feature transformation application running at the data analytic environment, a feature extraction and transformation application running at the data analytic environment, and a predictive analytics application running at the data analytic environment.

The data store application is configured to obtain, during a lifecycle of a current service request received by the system from an associated customer and prior to an end of the lifecycle of the current service request, factual customer experience data comprising customer touchpoint data representative of one or more touchpoints of the associated customer with the system during the current service request.

The feature transformation application is configured to generate mappings of the customer touchpoint data representative of the one or more touchpoints of the associated customer with the system with customer sentiment data representative of an emotion of the customer at each of the one or more touchpoints.

The feature extraction and transformation application is configured to translate the mappings to customer problem data representative of customer problems.

The predictive analytics application comprises one or more machine learning (ML) AI models trained based on one or more previous service request lifecycles of the associated customer to determine latent emotions of the associated customer that are detectable by the one or more ML AI models based on the customer problem data, wherein the predictive analytics application is configured to selectively generate a customer service prioritization signal indicative of a need to prioritize the current service request based on the determined latent emotions of the associated customer.

In any of the embodiments herein, the predictive analytics application is configured to selectively generate the customer service prioritization signal indicative of the need to prioritize the current service request during the lifecycle of the current service request and prior to the end of the lifecycle of the current service request.

In any of the embodiments herein, the one or more machine learning AI models of the predictive analytics application are trained to determine a customer effort score (CES) related to the determined latent emotions of the associated customer, and the one or more machine learning AI models of the predictive analytics application are configured to selectively generate the customer service prioritization signal based on a level of the determined CES relative to a predetermined escalation threshold CES of the associated customer.

In any of the embodiments herein, an agent user interface is provided running at the data analytic environment and in operative communication with the predictive analytics application, wherein the agent user interface is configured to render a proactive escalation management dashboard on a display device, and wherein the proactive escalation management dashboard comprises an image representation of the customer service prioritization signal for visual indication to an associated agent user of the system the need to prioritize the current service request based on the determined emotions of the associated customer.

In any of the embodiments herein, the data store application is configured to obtain, during a plurality of lifecycles of current service requests received by the system from a plurality of associated customers and prior to ends of the plurality of lifecycles of the plurality of current service requests, factual customer experience data comprising customer touchpoint data representative of one or more touchpoints of each of the plurality of associated customers with the system during the plurality of current service requests.

In any of the embodiments herein, the feature transformation application is configured to generate mappings of the plurality of customer touchpoint data representative of the one or more touchpoints of each of the plurality of associated customers with the system with customer sentiment data representative of an emotion of each of the plurality of customers at each of the one or more touchpoints.

In any of the embodiments herein, the feature extraction and transformation application is configured to translate the mappings to the customer problem data representative of customer problems, and the one or more machine learning AI models of the predictive analytics application are trained based on one or more previous service request lifecycles of each of the plurality of associated customers to determine latent emotions of each of the plurality of associated customers based on the customer problem data.

In any of the embodiments herein, the predictive analytics application is configured to selectively generate a plurality of customer service prioritization signals each being indicative of a need to prioritize the plurality of current service requests based on the determined latent emotions of each of the plurality of associated customers, and the proactive escalation management dashboard comprises a plurality of image representations of the plurality of customer service prioritization signals providing visual indication to the associated agent user of the system the need to prioritize the plurality of current service requests based on the determined emotions of the plurality of associated customers, and providing a visual cue to the associated agent user of relative severity rankings between each of the plurality of current service requests whereby the associated agent user may selectively tend to a first current service request having a first severity ranking before tending to a second current service request having a second severity ranking less than the first severity ranking of the first service request.

In any of the embodiments herein, the feature transformation application is configured to generate the mappings of the customer touchpoint data with the customer sentiment data as a dataset comprising a spreadsheet, the feature extraction and transformation application is configured to receive the dataset and to translate the mappings to the customer problem data in a descriptive analytic language, and the predictive analytics application is configured to receive the customer problem data translated to the descriptive analytic language and to selectively generate the customer service prioritization signal indicative of the need to prioritize the current service request based on the determined emotions of the associated customer.

In any of the embodiments herein, the one or more machine learning AI models of the predictive analytics application comprise one or more of a trained neural network model, a trained classification and regression tree (CART) model, and/or a trained Naive Bayes model, and the predictive analytics application is configured to selectively generate the customer service prioritization signal using the one or more of the trained neural network model, the trained CART model, and/or the trained Naive Bayes model, wherein the generated customer service prioritization signal is indicative of the need to prioritize the current service request based on the determined latent emotions of the associated customer.

In accordance with a further aspect, a method is provided for use with a data analytics environment to enable use of artificial intelligence (AI) in providing customer support.

The method includes providing a computer including one or more processors, that provides access to a data analytics environment.

The method further includes providing a data store application running at the data analytic environment, wherein the data store application obtains, during a lifecycle of a current service request received by the system from an associated customer and prior to an end of the lifecycle of the current service request, factual customer experience data comprising customer touchpoint data representative of one or more touchpoints of the associated customer with the system during the current service request.

The method further includes providing a feature transformation application running at the data analytic environment and operatively coupled with the data store application, wherein the feature transformation application generates mappings of the customer touchpoint data representative of the one or more touchpoints of the associated customer with the system with customer sentiment data representative of an emotion of the customer at each of the one or more touchpoints.

The method further includes providing a feature extraction and transformation application running at the data analytic environment and operatively coupled with the feature transformation application, wherein the feature extraction and transformation application translates the mappings to customer problem data representative of customer problems.

The method further includes providing a predictive analytics application running at the data analytic environment and operatively coupled with the feature extraction and transformation application, wherein the predictive analytics application comprises one or more machine learning (ML) AI models trained based on one or more previous service request lifecycles of the associated customer to determine latent emotions of the associated customer that are detectable by the one or more ML AI models based on the customer problem data, wherein the predictive analytics application generates a customer service prioritization signal indicative of a need to prioritize the current service request based on the determined latent emotions of the associated customer.

In accordance with a further aspect, a non-transitory computer readable medium having instructions thereon is provided for use with a data analytics environment to enable use of artificial intelligence (AI) in providing customer support for use with the data analytics environment. The instructions of the non-transitory computer readable medium, when run and executed cause the computer to perform steps comprising providing a computer including one or more processors, wherein the computer provides access to the data analytics environment.

The instructions of the non-transitory computer readable medium, when run and executed cause the computer to perform further steps comprising providing a data store application running at the data analytic environment, wherein the data store application obtains, during a lifecycle of a current service request received by the system from an associated customer and prior to an end of the lifecycle of the current service request, factual customer experience data comprising customer touchpoint data representative of one or more touchpoints of the associated customer with the system during the current service request.

The instructions of the non-transitory computer readable medium, when run and executed cause the computer to perform further steps comprising providing a feature transformation application running at the data analytic environment and operatively coupled with the data store application, wherein the feature transformation application generates mappings of the customer touchpoint data representative of the one or more touchpoints of the associated customer with the system with customer sentiment data representative of an emotion of the customer at each of the one or more touchpoints.

The instructions of the non-transitory computer readable medium, when run and executed cause the computer to perform further steps comprising providing a feature extraction and transformation application running at the data analytic environment and operatively coupled with the feature transformation application, wherein the feature extraction and transformation application translates the mappings to customer problem data representative of customer problems.

The instructions of the non-transitory computer readable medium, when run and executed cause the computer to perform further steps comprising providing a predictive analytics application running at the data analytic environment and operatively coupled with the feature extraction and transformation application, wherein the predictive analytics application comprises one or more machine learning (ML) AI models trained based on one or more previous service request lifecycles of the associated customer to determine latent emotions of the associated customer that are detectable by the one or more ML AI models based on the customer problem data, wherein the predictive analytics application generates a customer service prioritization signal indicative of a need to prioritize the current service request based on the determined latent emotions of the associated customer.

### BRIEF DESCRIPTION OF THE DRAWINGS

FIG. 1 illustrates a system for providing a cloud infrastructure or data analytics environment, in accordance with an embodiment.

FIG. 2 further illustrates a system for providing a cloud infrastructure or data analytics environment, in accordance with an embodiment.

FIG. 3 illustrates an example use of the system to provide a data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 further illustrates an example data analytics environment, in accordance with an embodiment.

FIG. 8 further illustrates an example data analytics environment, in accordance with an embodiment.

FIG. 9 illustrates a system for use with a data analytics environment to enable use of AI in providing customer support, in accordance with an embodiment.

FIG. 10 is an illustration of a full life cycle of a service request from a customer.

FIG. 11 illustrates a screenshot produced by a system for use with a data analytics environment to enable use of AI in providing customer support, in accordance with an embodiment.

FIG. 12 illustrates a screenshot produced by a system for use with a data analytics environment to enable use of AI in providing customer support, in accordance with an embodiment.

FIG. 13 illustrates a screenshot produced by a system for use with a data analytics environment to enable use of AI in providing customer support, in accordance with an embodiment.

FIG. 14 illustrates a flowchart of a method for use with a data analytics environment to provide escalation management predictive analytics using one or more trained machine learning AI models for use with the data analytics environment, in accordance with an embodiment.

### DETAILED DESCRIPTION

Generally described, within an organization, data analytics enables computer-based examination of large amounts of data, for example to derive conclusions or other information from the data. For example, business intelligence (BI) tools can be used to provide users with business intelligence describing their enterprise data, in a format that enables the users to make strategic business decisions.

Increasingly, data analytics can be provided within the context of enterprise software application environments, such as, for example, an Oracle Fusion Applications environment; or within the context of software-as-a-service (SaaS) or cloud environments, such as, for example, an Oracle Analytics Cloud or Oracle Cloud Infrastructure environment; or other types of analytics application or cloud environments.

Examples of data analytics environments and business intelligence tools/servers include Oracle Business Intelligence Server (OBIS), Oracle Analytics Cloud (OAC), and Fusion Analytics Warehouse (FAW), which support features such as data mining or analytics, and analytic applications.

### Cloud Infrastructure Environments

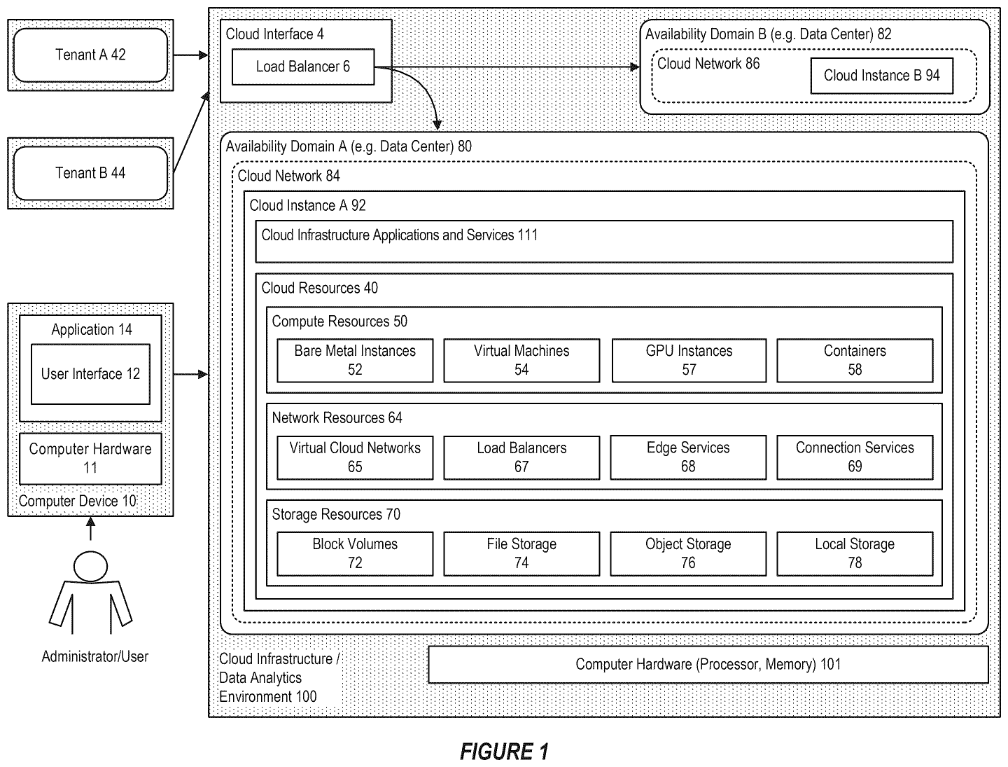

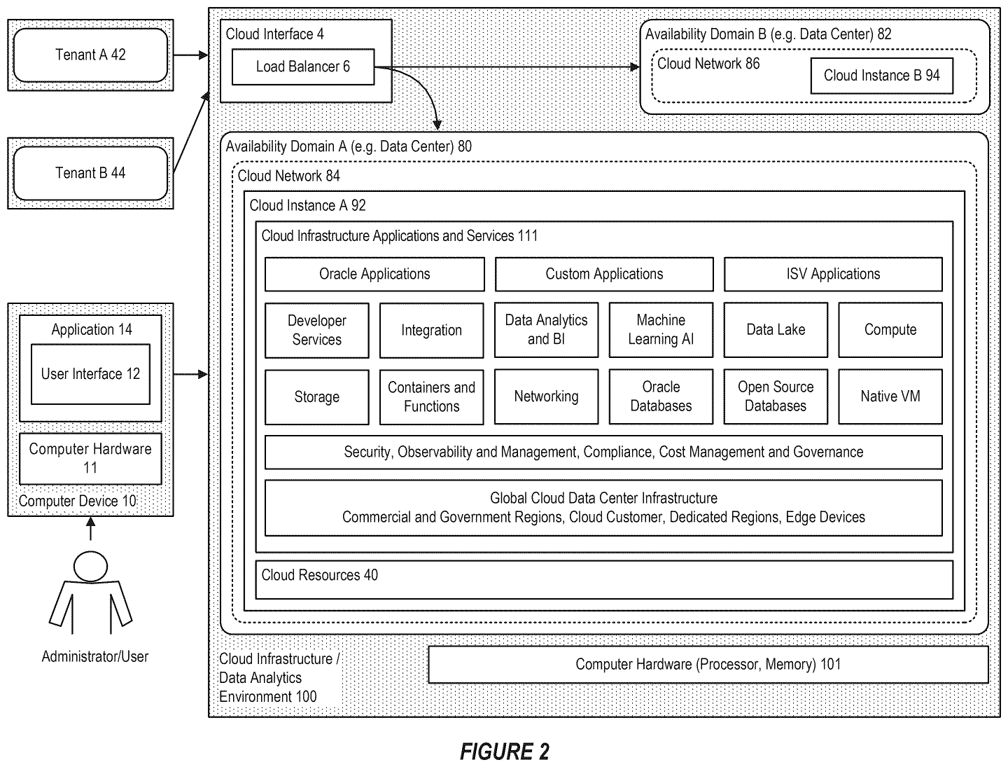

FIGS. 1 and 2 illustrate a system for providing a cloud infrastructure or data analytics environment, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system, or other suitably-programmed computer system.

The illustrated example is provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure or data analytics environment 100 can operate on a cloud computing infrastructure 101 comprising hardware (e.g., processor, memory), software resources, and one or more cloud interfaces 4 or other application program interfaces (API) that provide access to the shared cloud resources via one or more load balancers 6.

In accordance with an embodiment, the cloud infrastructure environment supports the use of availability domains, such as, for example, availability domains A 80, B 82, which enables customers to create and access cloud networks 84, 86, and run cloud instances A 92, B 94.

In accordance with an embodiment, a tenancy can be created for each cloud tenant/customer, for example tenant A 42, B 44, which provides a secure and isolated partition within the cloud infrastructure environment within which the customer can create, organize, and administer their cloud resources. A cloud tenant/customer can access an availability domain and a cloud network to access each of their cloud instances.

In accordance with an embodiment, a client device, such as, for example, a computing device 10 having a device hardware 11 (e.g., processor, memory), application 14 and graphical user interface 12, can enable an administrator other user to communicate with the cloud infrastructure environment via a network such as, for example, a wide area network, local area network, or the Internet, to create or update cloud services.

In accordance with an embodiment, the cloud infrastructure environment provides access to shared cloud resources 40 via, for example, a compute resources layer 50, a network resources layer 64, and/or a storage resources layer 70. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 52, virtual machines 54, graphical processing unit (GPU) compute cloud instances 57, and/or containers 58. The compute resources layer can be used to, for example, provision and manage bare metal compute cloud instances, or provision cloud instances as needed to deploy and run applications, as in an on-premises data center.

For example, in accordance with an embodiment, the cloud infrastructure environment can provide control of physical host (bare metal) machines within the compute resources layer, which run as compute cloud instances directly on bare metal servers, without a hypervisor.

In accordance with an embodiment, the cloud infrastructure environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 65, load balancers 67, edge services 68, and/or connection services 69.

In accordance with an embodiment, the storage resources layer can comprise a number of resources, such as, for example, data/block volumes 72, file storage 74, object storage 76, and/or local storage 78.

In accordance with an embodiment, the cloud environment can include a container orchestration system, and container orchestration system API, that enables containerized application workflows to be deployed to a container orchestration environment, for example a Kubernetes (k8s) cluster.

For example, in accordance with an embodiment, the cloud environment can be used to provide containerized compute cloud instances within the compute resources layer, and a container orchestration implementation (e.g., Oracle Cloud Infrastructure Container Engine for Kubernetes (OKE)), can be used to build and launch containerized applications or cloud-native applications, specify compute resources that the containerized application requires, and provision the required compute resources.

As illustrated in FIG. 2, in accordance with an embodiment, the cloud infrastructure or data analytics environment can include a range of complementary cloud-based components, for example as cloud infrastructure applications and services 111, that enable organizations or enterprise customers to operate their applications and services in a highly-available hosted environment.

By way of example, in accordance with an embodiment, a self-contained cloud region can be provided as a complete, e.g., Oracle Cloud Infrastructure (OCI) dedicated region within an organization's data center that offers the data center operator the agility, scalability, and economics of a public cloud, while retaining full control of their data and applications to meet security, regulatory, or data residency requirements.

### Data Analytics Environments

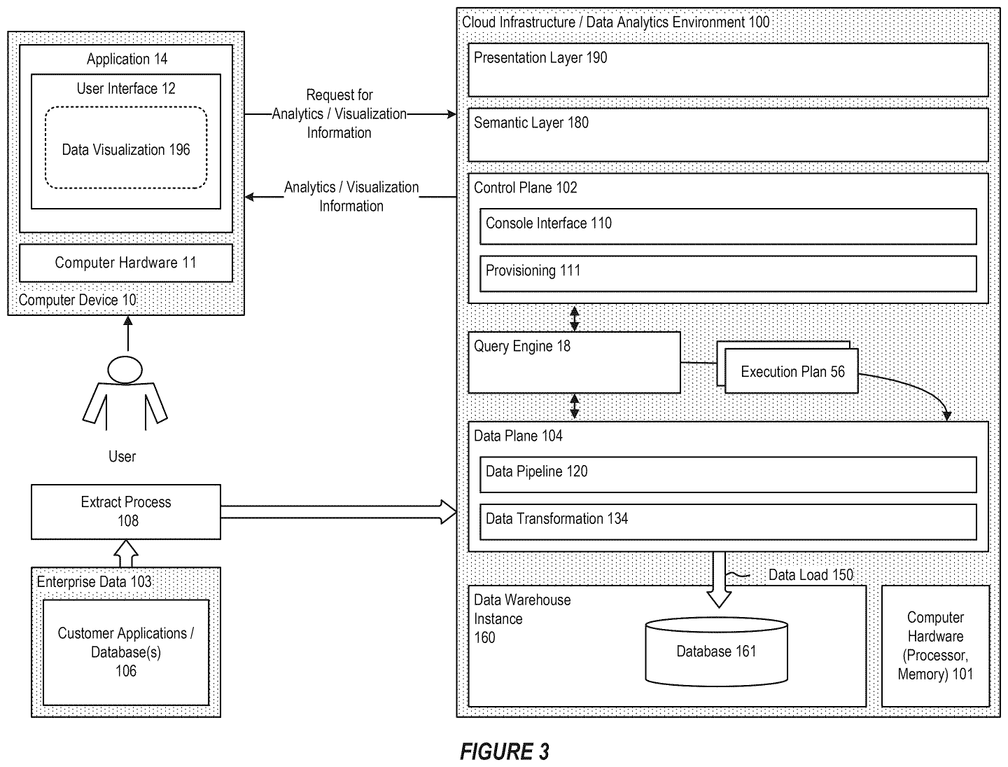

FIG. 3 illustrates an example use of the system to provide a data analytics environment, in accordance with an embodiment.

The example embodiment illustrated in FIG. 3 is provided for purposes of illustrating an example of a data analytics environment in association with which various embodiments described herein can be used. In accordance with other embodiments and examples, the approach described herein can be used with other types of data analytics, database, or data warehouse environments.

As illustrated in FIG. 3, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access in the manner of a data layer to a data warehouse instance 160 (e.g., having a database 161, or other type of data source).

In accordance with an embodiment, the control plane operates to provide control for cloud or other software products offered within the context of a cloud environment. For example, in accordance with an embodiment, the control plane can include a console interface 110 that enables access by a customer (tenant) and/or a cloud environment having a provisioning component 111, for example to allow customers to provision services for use within their enterprise environment. The provisioning component can provision a data warehouse instance, including a customer schema of the data warehouse; and populate the data warehouse instance with the appropriate information supplied by the customer.

In accordance with an embodiment, the data plane can include a data pipeline or process layer 120 and a data transformation layer 134, that together process data from an organization's enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization's enterprise software environment, transforming the extracted data into a model format, and loading the transformed data into a customer schema of the data warehouse.

For example, in accordance with an embodiment, each customer (tenant) of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract enterprise data 103 from an enterprise software environment, such as, for example, business productivity software applications and corresponding databases 106.

In accordance with an embodiment, an extract process 108 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers may have different requirements with regard to how their data is classified, aggregated, or transformed, for providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a customer may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, analytics dashboard, key performance indicators (KPI's); or other type of report or interface as may be provided by products such as, for example, Oracle Analytics Cloud, or Oracle Analytics for Applications.

In accordance with an embodiment, a query engine 18 (e.g., an Oracle Business Intelligence Server, OBIS instance) operates in the manner of a federated query engine to serve analytical queries or requests from clients directed to data stored at a database. The query engine can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 10 that includes a computer hardware 11 (e.g., processor, storage, memory), user interface 12, and client application 14. A query engine or business intelligence server generally operates to process inbound, e.g., SQL, requests against a database model, build and execute one or more physical database queries, process the data appropriately, and return the data in response to the request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation the query engine can create a query execution plan which can then be further optimized, for example to perform aggregations of data necessary to respond to a request. Data can be combined together and further calculations applied, before the results are returned to the calling application.

In accordance with an embodiment, a request for data analytics or visualization information can be received via a client application and user interface as described above, and communicated to the data analytics environment (in the example of a cloud environment, via a cloud service). The system can retrieve an appropriate dataset to address the user/business context, for use in generating and returning the requested data analytics or visualization information to the client, as a data visualization 196.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

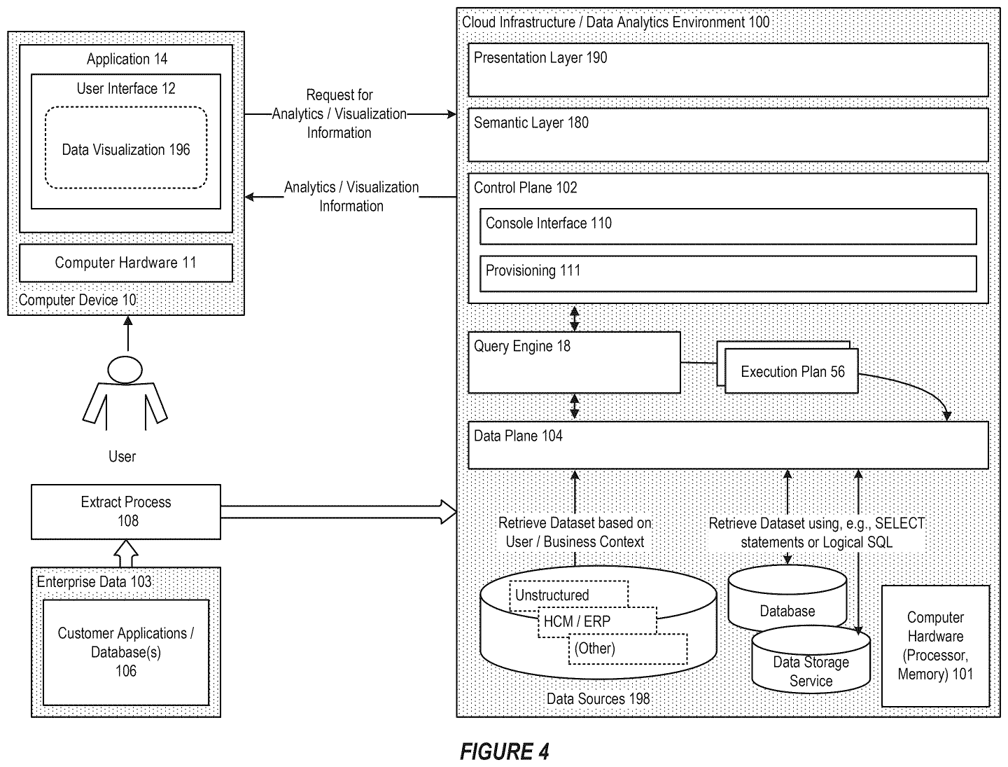

FIG. 4 further illustrates an example data analytics environment, in accordance with an embodiment.

As illustrated in FIG. 4, in accordance with an embodiment, the data analytics environment enables a dataset to be retrieved, received, or prepared from one or more data source(s) 198, for example via one or more data source connections. Examples of the types of data that can be transformed, analyzed, or visualized using the systems and methods described herein include data directed to Enterprise Resource Planning (ERP), Human Capital Management (HCM), or Human Resources (HR), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

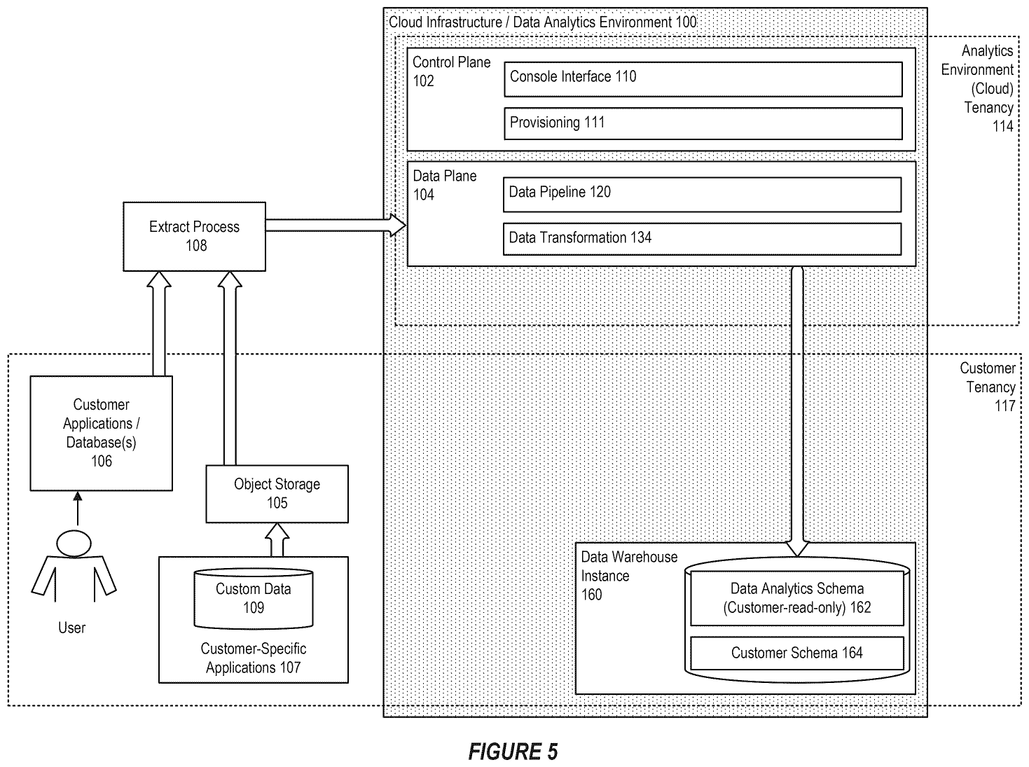

FIG. 5 further illustrates an example data analytics environment, in accordance with an embodiment.

As illustrated in FIG. 5, in accordance with an embodiment, data can be sourced, e.g., from a customer's (tenant's) enterprise software environment (106), using the data pipeline process; or as custom data 109 sourced from one or more customer-specific applications 107; and loaded to a data warehouse instance, including in some examples the use of an object storage 105 for storage of the data. A user can create a dataset that uses tables from different connections and schemas. The system uses the relationships defined between these tables to create relationships or joins in the dataset.

In accordance with an embodiment, the data warehouse can include a default data analytics schema 162 and, for each customer (tenant) of the system, a customer schema 164. For each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse can include a data analytics schema and, for each customer/tenant, a customer schema sourced from their enterprise software environment. The data provisioned in a data warehouse tenancy is accessible only to that tenant; while at the same time allowing access to various, e.g., ETL-related or other features of the shared environment.

In accordance with an embodiment, for a particular customer/tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

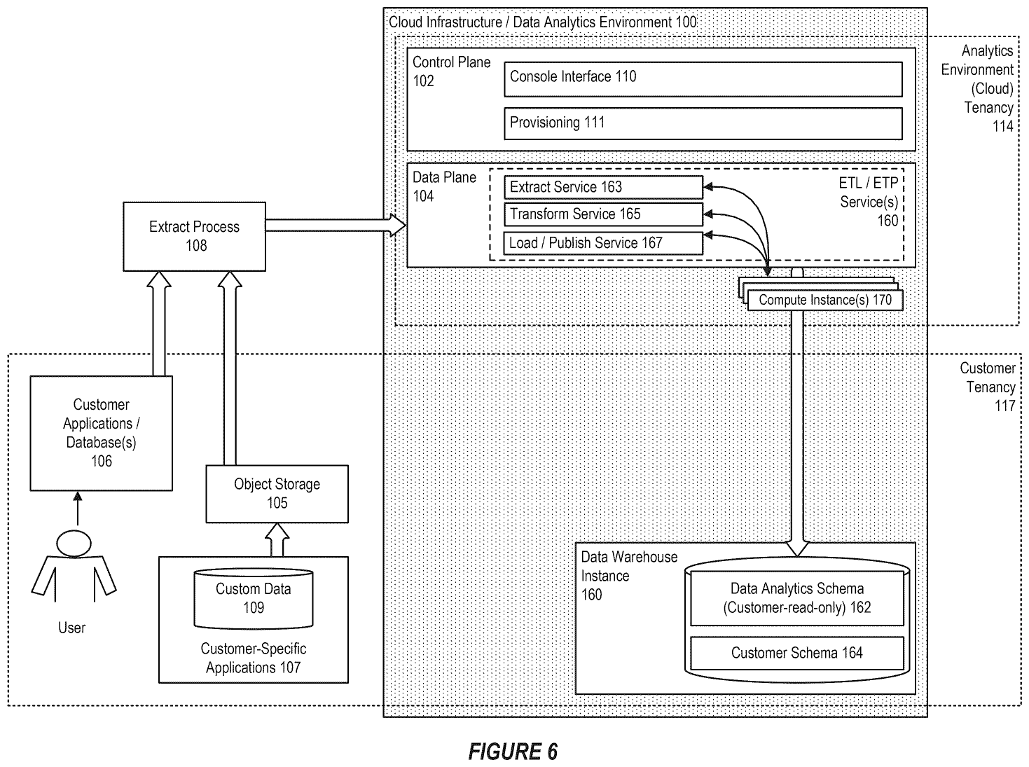

FIG. 6 further illustrates an example data analytics environment, in accordance with an embodiment.

As illustrated in FIG. 6, in accordance with an embodiment, the process of extracting data from a customer's (tenant's) enterprise software environment, and loading the data to a data warehouse instance, or refreshing the data in a data warehouse, generally involves several stages, performed by an ETP service 160 or process, including one or more extraction service 163; transformation service 165; and load/publish service 167, executed by one or more compute instance(s) 170.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the customer (tenant). A load/publish service or process takes the data from the ADW database and publishes it to a data warehouse instance that is accessible to the customer (tenant).

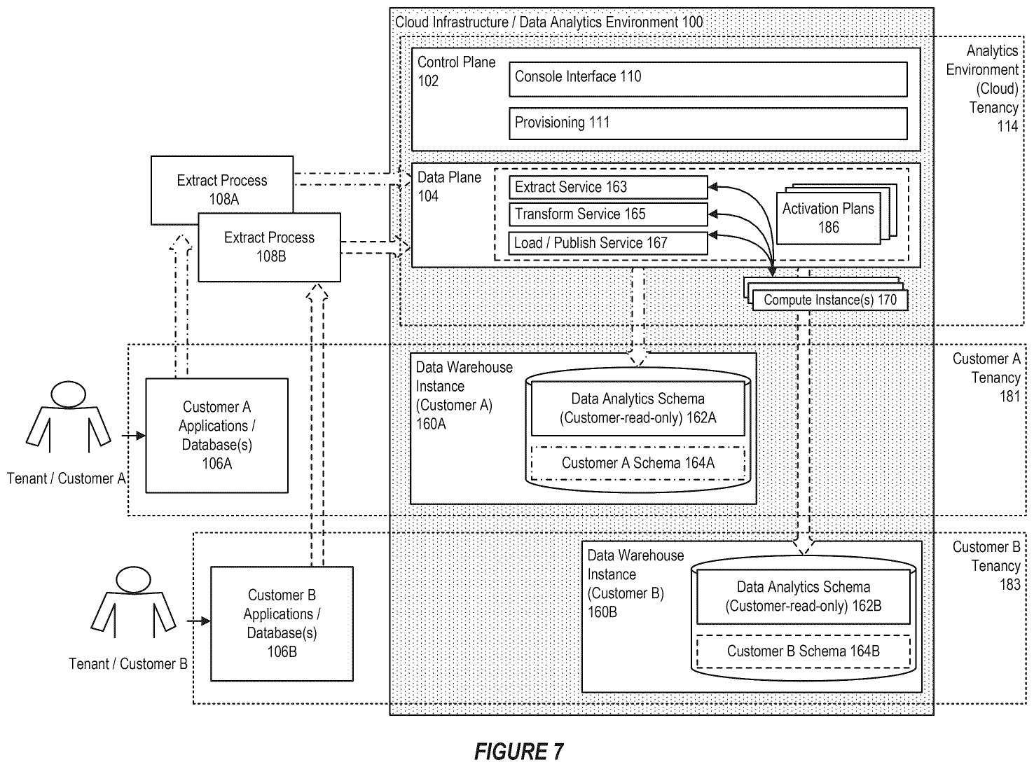

FIG. 7 further illustrates an example data analytics environment, in accordance with an embodiment.

As illustrated in FIG. 7, in accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case. For each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs. For example, an activation plan can define a number of extract, transform, and load (publish) services or steps to be run in a certain order, at a certain time of day, and within a certain window of time.

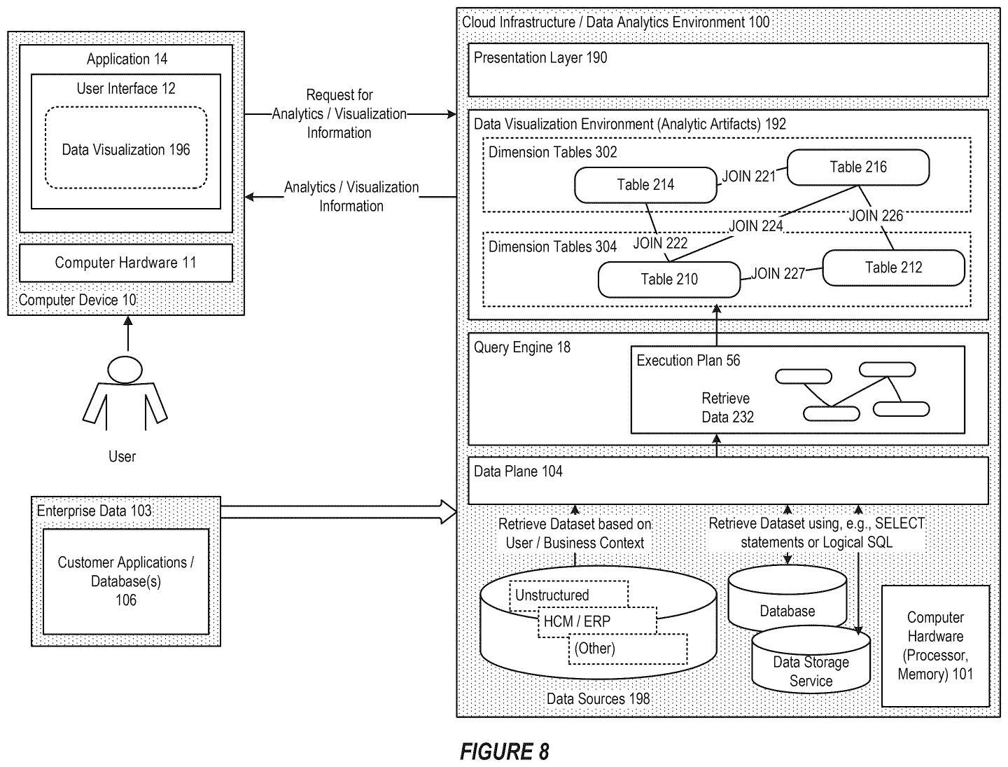

FIG. 8 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 8, in accordance with an embodiment, the data analytics environment enables a dataset to be retrieved, received, or prepared from one or more data source(s), for example via one or more data source connections, fact and/or dimension tables 210, 212, 214, 216, or joins 221, 222, 224, 226, 227 between selections of dimension tables 302, 304.

In accordance with an embodiment, a request received at a data visualization environment to display analytic artifacts 192, for example as may be related to key performance indicators, analytics dashboards, or scorecards, can be received via a client application and user interface as described above, and communicated to the data analytics environment via a cloud service. The system can retrieve 232 an appropriate dataset using, e.g., SELECT statements, to address the user/business context, for use in generating and returning the requested data analytics or visualization information to the client.

### Use of AI in Providing Customer Support

As described above, customer support has evolved a great deal in the last decade. It has shifted recently from being a cost center to becoming a revenue center. Customer support is becoming a point of discussion and a key differentiator in the agreement stage in negotiations with prospective users such as prospective software users for example. Criticality and urgency relative to support for software uses is the norm. A full and complete uptime twenty fours a day and seven days per week is an expectation and not an exception. Customers want faster resolutions, and that time factor only gets shorter and more compressed.

A question for any organization may be whether their contact center lives up to the expectations of the software users or customers. This is generally not the case because research suggests customer escalation increases exponentially, and organizations spend millions of dollars annually. It does not end here, wherein if escalations of software users or customers are not handled well, an organization may lose not just its present customers but future customers as they may be making decisions based on support and service rather than putting the decision on purchases, upgrades and the like on price, function, or feature.

Much research shows that customer effort equates to loyalty. The more effortless the support experience is to a customer, the more loyal the customer will be to the brand. Hence, there is a switch in the industry from focusing on customer satisfaction to focusing on customer effort score (CES). This being the case, for customers to see more value in a service, seller or provider organizations need to prevent/deflect of support request escalations, improve contact center efficiency, and provide an effortless experience (high CES), which will help with a high customer retention rate and avoid lost revenue. Handling the underlying support ticket after an escalation occurs is very expensive for organizations, amounting to millions of dollars annually. Furthermore, software defect escalations can, if not handled properly, result in a loss of reputation, satisfaction, loyalty, and customers.

Sentiment analysis has been used by various entities in the market for determining customer satisfaction. However, on most occasions, the customers are already frustrated by the time they reach support. There is a need in the art, therefore, for systems, methods, and computer readable medium storing programs that when executed enable use of AI in providing customer support wherein end user customer support request escalations may be preemptively addressed and/or deflected before exceeding a determined threshold.

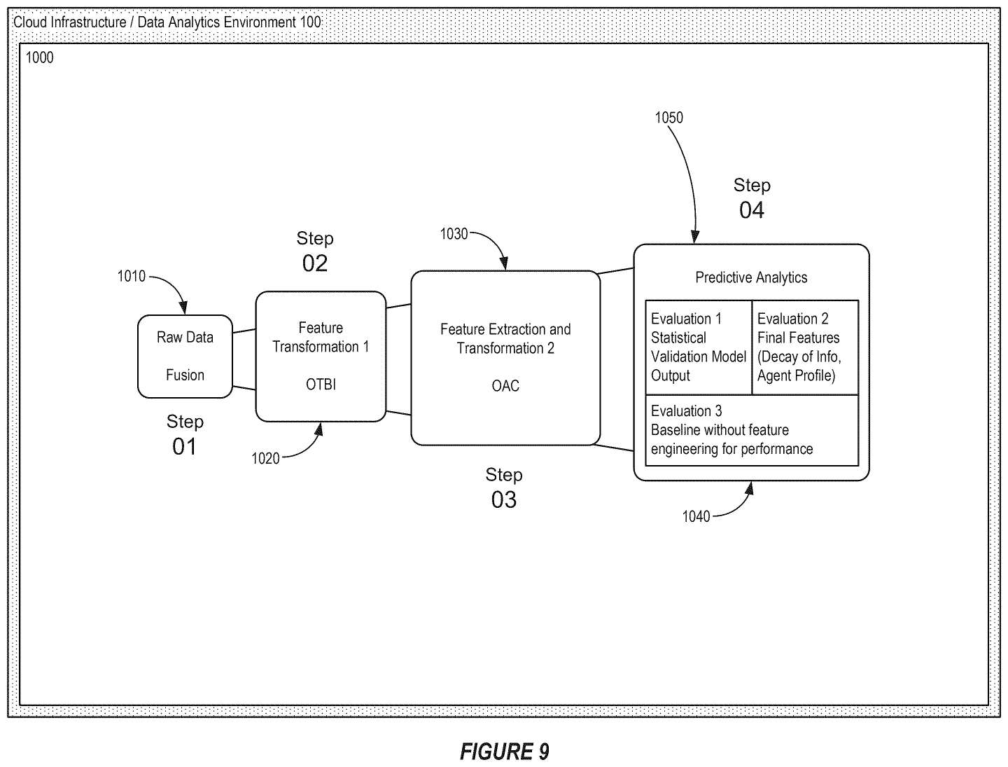

FIG. 9 illustrates a system 1000 for use with a data analytics environment 100 to enable use of AI in providing customer support, in accordance with an embodiment. As shown there, the system 1000 includes a data store application 1010 operatively coupled with a feature transformation application 1020 that is in turn operatively couped with a feature extraction and transformation application 1030 that is in turn operatively coupled with a predictive analytics application 1040.

In general, the system 1000 for use with the data analytics environment 100 provides escalation management predictive analytics using one or more trained machine learning (ML) AI models for use with the data analytics environment, in accordance with an embodiment.

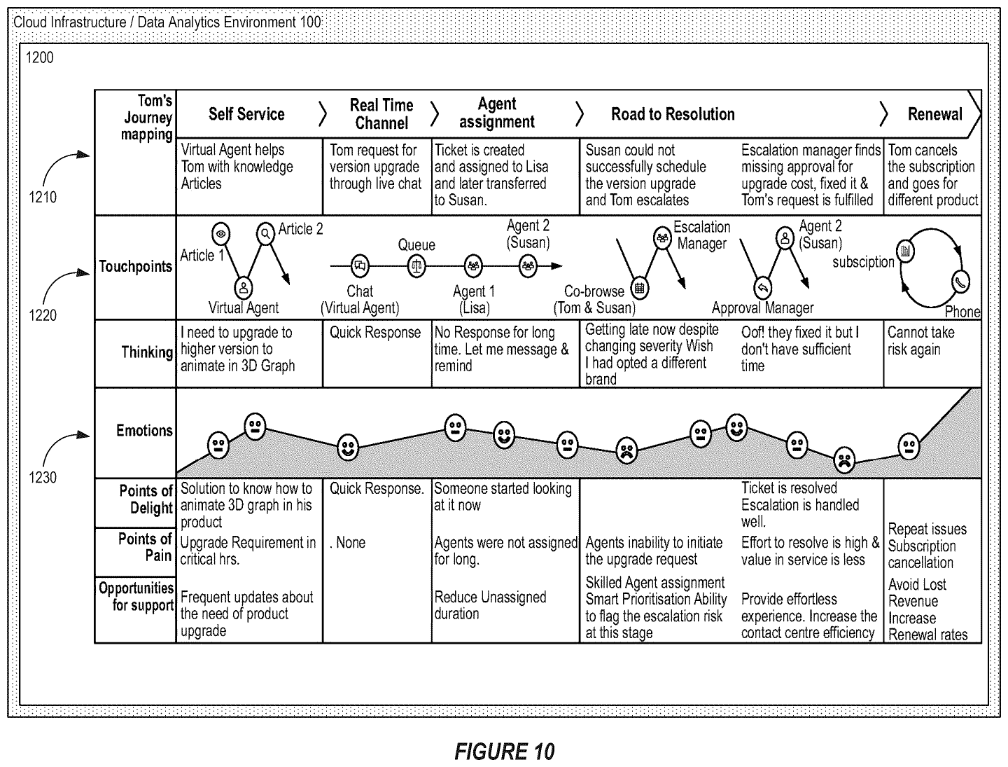

In accordance with an embodiment, the touch points 1220 (FIG. 10) of a service request model across the ticket lifecycle 1210 (FIG. 10) are mapped to customer emotions 1230 FIG. 10) and points of pain. These mappings are translated to problems in descriptive analytics language and fed as input to machine learning models. The models are trained with the problems of every touch point so that they can upfront flag all tickets that need immediate attention before they snowball into escalations or can potentially affect the Customer Effort Score. The proactive escalation management dashboard will have these predictions that can be used for smart prioritization or to trigger workflows that can initiate an action item to the agent.

In accordance with an embodiment, using Oracle CX customer base as an example, an approach can be based on enriched service subject areas in the feature transformation application 1020 and scaled with additional features on the final extracted dataset in the feature extraction and transformation application 1030.

In accordance with an example embodiment, the feature transformation application 1020 may comprise an Oracle Transaction Business Intelligence (OBTI) application for example, and the feature extraction and transformation application 1030 may comprise Oracle Analytics Cloud (OAC). Additional features can be built out of the box in OTBI, further simplifying the solution.

Customization is another major reason for this approach. Customers can easily map the custom fields (Custom severity) to OOTB fields (OOTB severity) used in the data set. The entire approach is user friendly, less expensive and more importantly, explainable prediction results. A further aspect of opting for the approach of the example embodiments is data security, which is ensured at every level.

In accordance with an embodiment, the predictive analytics application 1040 of the system 1000 can use Logistic Regression classification and Naive Bayes models for escalation and SLA violation prediction. Other models that may be presented in the predictive analytics application 1040 may include Random Forest, or CART classification, for example that can also be used.

In accordance with an embodiment, the system 1000 can use a CART model for predicting ticket age. This prediction was made during assignment time based on previous trends. Post assignment and change in status, it will not linearly continue the prediction. This prediction is valid only at a point when the Agent starts working and changes the status of the SR to In Progress. This is to assess early risk. Other models, like Linear regression, or Neural Network, can also be used.

In accordance with an embodiment, the system 1000 is operative to provide plural different data sets, wherein in the example embodiments described four different data sets are provided although more or less data sets may be provided. Each of the plural different data sets addresses different aspects (Fundamental aspects, Time aspects, Customer bio, Support bio) of the extracted or otherwise determined feature, wherein the plural different data sets are iteratively used during training of the predictive analytics application 1040 for the first time. These iterative phases are used as the feedback cycles emphasize producing the best-expected results over the baseline (Fundamental Aspects). Customers can customize this by mapping it with their equivalent custom fields.

In accordance with an embodiment, the described approach can be used with existing Oracle CX customers and brings all of them to the OAC platform, with 100% end-user customizable features, and respects data security at all levels.

In accordance with an embodiment, instead of identifying various signals and doing sentiment analysis that can help improve future trends, the approach of the example embodiments described herein capture emotions on all the customer touch points and uses them to reflect the current trend itself. The feature extraction and transformation application 1030 of the system 1000 can feed problems as input into the one or more training models of the predictive analytics application 1040, rather than the raw data obtained from or otherwise available in the data store application 1010. The problems mapped with touch points will be the same for all end user customers using a particular service, although the data shape of the problem can change from one end user customer to another. So, any possible data validation threat of all the one or more training models of the predictive analytics application 1040 used is exponentially reduced compared to other models.

The end user customer need not understand the technicality of the service implementation nor need access to the underlying DB/query for customization. On similar lines, the system implementer need not have access to the customer data. The dataset can be stabilized based on the statistical evaluation results obtained.

In accordance with the example embodiment, the data store application 1010 of the system 1000 stores raw data related to complete lifecycles of user support requests.

The data store application 1010 running at the data analytic environment 100 is configured to obtain, during a lifecycle of a current service request received by the system from an associated customer and prior to an end of the lifecycle of the current service request, factual customer experience data comprising customer touchpoint data representative of one or more touchpoints of the associated customer with the system during the current service request.

The feature transformation application 1020 running at the data analytic environment 100 is configured to generate mappings of the customer touchpoint data representative of the one or more touchpoints of the associated customer with the system with customer sentiment data representative of an emotion of the customer at each of the one or more touchpoints.

The feature extraction and transformation application 1030 running at the data analytic environment 100 is configured to translate the mappings to customer problem data representative of customer problems.

The predictive analytics application 1040 running at the data analytic environment 100 comprises one or more machine learning (ML) AI models 1050 trained based on one or more previous service request lifecycles of the associated customer to determine latent emotions of the associated customer that are detectable by the one or more ML AI models based on the customer problem data, wherein the predictive analytics application is configured to selectively generate a customer service prioritization signal indicative of a need to prioritize the current service request based on the determined latent emotions of the associated customer.

In any of the embodiments, the predictive analytics application 1030 is configured to selectively generate the customer service prioritization signal indicative of the need to prioritize the current service request during the lifecycle of the current service request and prior to the end of the lifecycle of the current service request.

In any of the embodiments, the one or more machine learning AI models 1050 of the predictive analytics application 1040 are trained to determine a customer effort score (CES) related to the determined latent emotions of the associated customer, and the one or more machine learning AI models 1050 of the predictive analytics application 1040 are configured to selectively generate the customer service prioritization signal based on a level of the determined CES relative to a predetermined escalation threshold CES of the associated customer.

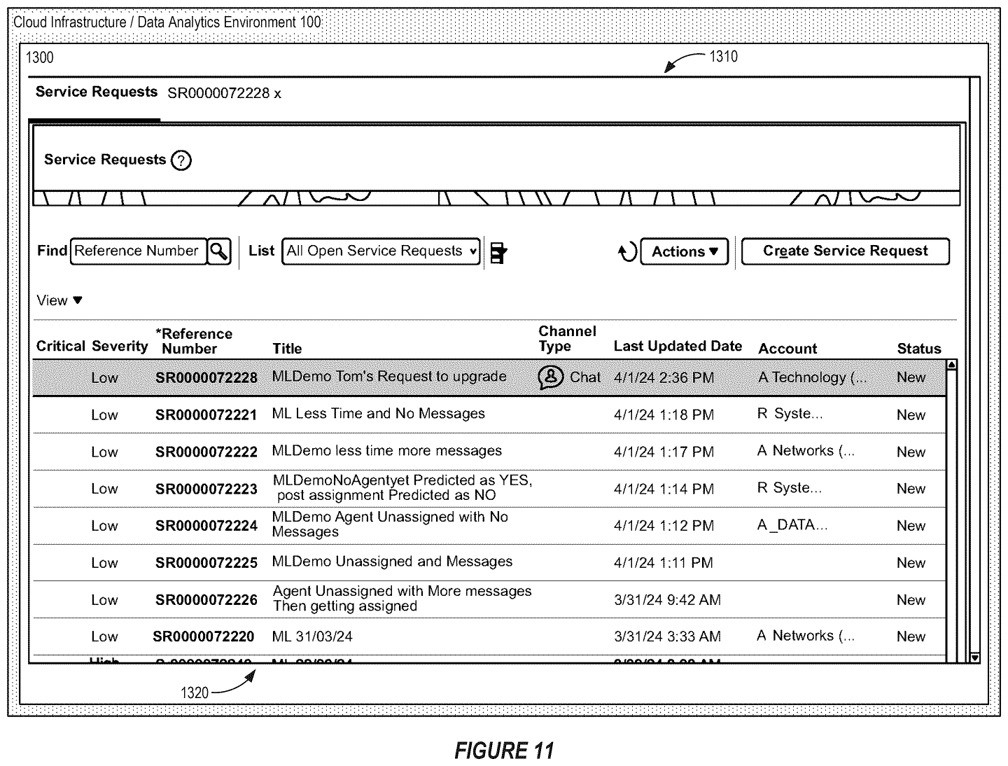

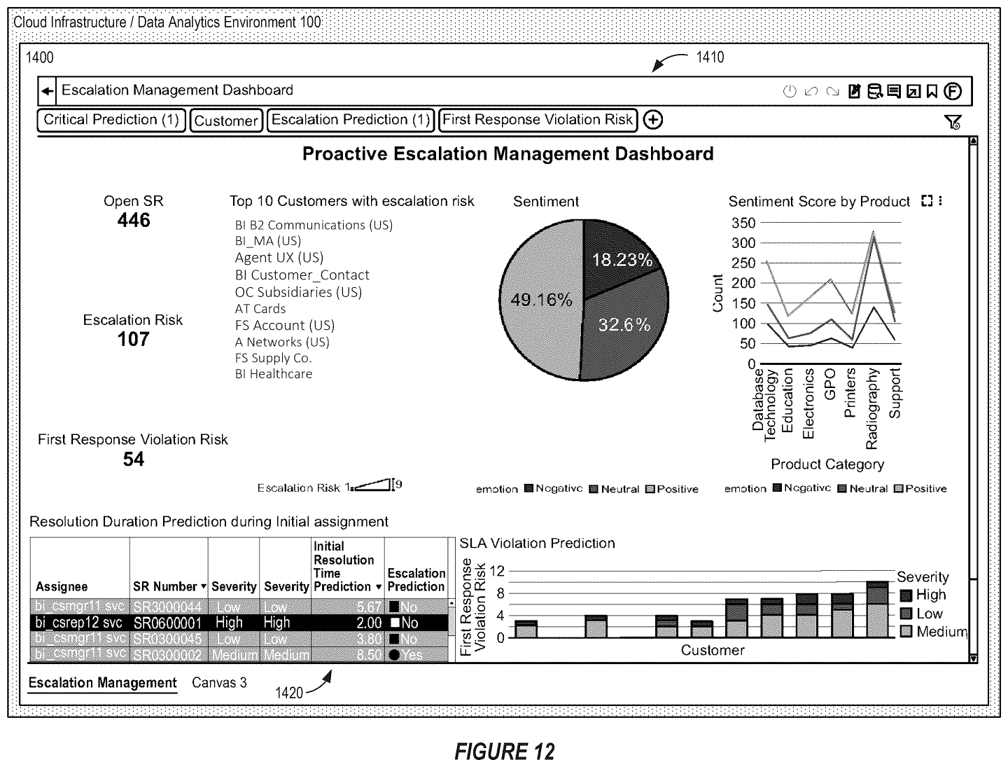

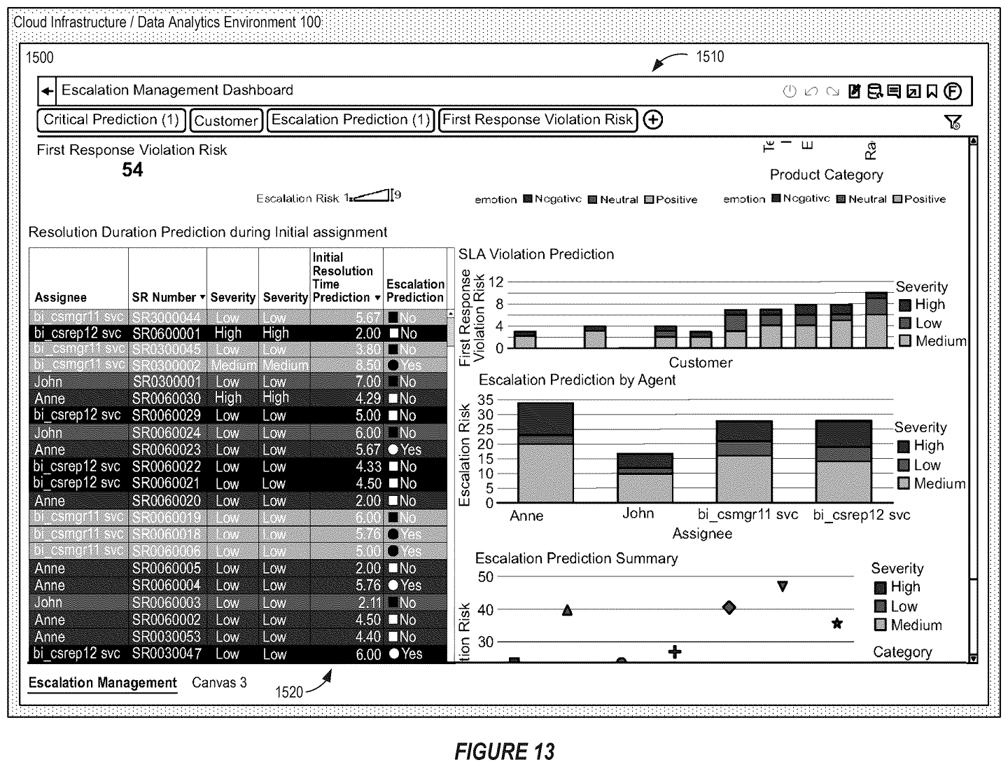

In any of the embodiments, an agent user interface running at the data analytic environment and in operative communication with the predictive analytics application, wherein the agent user interface is configured to render a proactive escalation management dashboard 1310 (FIG. 11), 1410 (FIG. 12), 1510 (FIG. 13) on a display device, wherein the proactive escalation management dashboard comprises an image representation of the customer service prioritization signal for visual indication to an associated agent user of the system the need to prioritize the current service request based on the determined emotions of the associated customer.

In any of the embodiments, the data store application 1010 is configured to obtain, during a plurality of lifecycles of current service requests received by the system from a plurality of associated customers and prior to ends of the plurality of lifecycles of the plurality of current service requests, factual customer experience data comprising customer touchpoint data representative of one or more touchpoints of each of the plurality of associated customers with the system during the plurality of current service requests.

In any of the embodiments, the feature transformation application 1020 is configured to generate mappings of the plurality of customer touchpoint data representative of the one or more touchpoints of each of the plurality of associated customers with the system with customer sentiment data representative of an emotion of each of the plurality of customers at each of the one or more touchpoints, wherein the feature extraction and transformation application 1030 is configured to translate the mappings to the customer problem data representative of customer problems;

In any of the embodiments, the one or more machine learning AI models 1050 of the predictive analytics application 1040 are trained based on one or more previous service request lifecycles of each of the plurality of associated customers to determine latent emotions of each of the plurality of associated customers based on the customer problem data, and the predictive analytics application is configured to selectively generate a plurality of customer service prioritization signals each being indicative of a need to prioritize the plurality of current service requests based on the determined latent emotions of each of the plurality of associated customers.

In any of the embodiments, the proactive escalation management dashboard 1310 (FIG. 11), 1410 (FIG. 12), 1510 (FIG. 13) comprises a plurality of image representations of the plurality of customer service prioritization signals 1320 (FIG. 11), 1420 (FIG. 12), 1520 (FIG. 13) providing visual indication to the associated agent user of the system the need to prioritize the plurality of current service requests based on the determined emotions of the plurality of associated customers, and providing a visual cue to the associated agent user of relative severity rankings between each of the plurality of current service requests whereby the associated agent user may selectively tend to a first current service request having a first severity ranking before tending to a second current service request having a second severity ranking less than the first severity ranking of the first service request.

In any of the embodiments, the feature transformation application 1020 is configured to generate the mappings of the customer touchpoint data with the customer sentiment data as a dataset comprising a spreadsheet, the feature extraction and transformation application is configured to receive the dataset and to translate the mappings to the customer problem data in a descriptive analytic language, and the predictive analytics application is configured to receive the customer problem data translated to the descriptive analytic language and to selectively generate the customer service prioritization signal indicative of the need to prioritize the current service request based on the determined emotions of the associated customer.

In any of the embodiments, the one or more machine learning AI models 1050 of the predictive analytics application 1040 comprise one or more of a trained neural network model, a trained classification and regression tree (CART) model, and/or a trained Naive Bayes model, wherein the predictive analytics application 1040 is configured to selectively generate the customer service prioritization signal using the one or more of the trained neural network model, the trained CART model, and/or the trained Naive Bayes model, wherein the generated customer service prioritization signal is indicative of the need to prioritize the current service request based on the determined latent emotions of the associated customer.

FIG. 10 is an illustration 1200 of a full lifecycle 1210 of a service request received from the system 1000 from an associated customer.

As described above, in general, the system 1000 for use with the data analytics environment 100 provides escalation management predictive analytics using one or more trained machine learning (ML) AI models for use with the data analytics environment, in accordance with an embodiment.

In accordance with an embodiment, the touch points 1220 of a service request model across the ticket lifecycle 1210 are mapped to customer emotions 1230 and points of pain. These mappings are translated to problems in descriptive analytics language and fed as input to machine learning models. The models are trained with the problems of every touch point so that they can upfront flag all tickets that need immediate attention before they snowball into escalations or can potentially affect the Customer Effort Score. The proactive escalation management dashboard will have these predictions that can be used for smart prioritization or to trigger workflows that can initiate an action item to the agent.

FIG. 11 illustrates a screenshot 1300 produced by a system for use with a data analytics environment to enable use of AI in providing customer support, in accordance with an embodiment.

In accordance with an embodiment, FIG. 11 shows an exemplary service request dashboard 1310, in accordance with an embodiment.

FIG. 12 illustrates a screenshot 1400 produced by a system 1000 for use with a data analytics environment to enable use of AI in providing customer support, in accordance with an embodiment.

In accordance with an embodiment, FIG. 12 shows an exemplary proactive escalation management dashboard 1410. For example, FIG. 12 can display a Top N number of sources of service request escalation requests, based upon one or more training models. Such a dashboard can also display, for example, a SLA violation prediction.

FIG. 13 illustrates a screenshot 1500 produced by a system for use with a data analytics environment to enable use of AI in providing customer support, in accordance with an embodiment.

In accordance with an embodiment, FIG. 13 shows a further exemplary proactive escalation management dashboard 1510. For example, FIG. 13 can a resolution duration prediction during initial assignment chart, where such chart is based upon one or more trained machine learning AI models, wherein the models are trained to determine latent emotions of the associated customer based on the customer problem data, and to selectively generate a customer service prioritization signal indicative of a need to prioritize the current service request based on the determined emotions of the associated customer models. The customer service prioritization signal indicative of the need to prioritize the current service request based on the determined emotions of the associated customer models may be visually represented in the proactive escalation management dashboard 1510, for example. The dashboard 1510 can also display, for example, an escalation prediction by agent, by associated customer, as well as an escalation prediction summary.

The dashboard 1510 can also display, for example, escalation predictions for a plurality of agents, wherein each of the escalation predictions may be displayed separately for each agent collectively on the dashboard 1510 for side-by-side comparison thereby advantageously providing for a visual ranking between the escalation predictions for the plurality of agents.

The dashboard 1510 can also display, for example, escalation predictions for a plurality of end user customers, wherein each of the escalation predictions may be displayed separately for each end user customer collectively on the dashboard 1510 for side-by-side comparison thereby advantageously providing for a visual ranking between the escalation predictions for the plurality of end user customers.

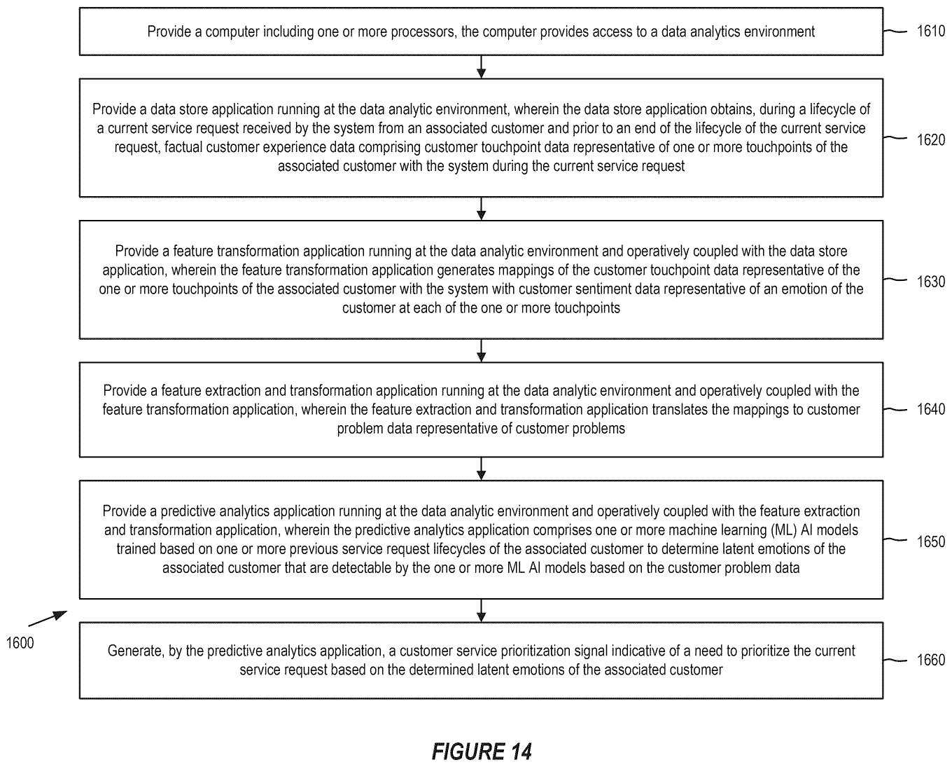

FIG. 14 illustrates a flowchart of a method 1600 for use with a data analytics environment to provide escalation management predictive analytics using one or more trained machine learning AI models for use with the data analytics environment, in accordance with an embodiment.

In accordance with an embodiment, at step 1610, the method can provide a computer including one or more processors, wherein the computer provides access to a data analytics environment.

In accordance with an embodiment, at step 1620, the method can provide a data store application running at the data analytic environment, wherein the data store application obtains, during a lifecycle of a current service request received by the system from an associated customer and prior to an end of the lifecycle of the current service request, factual customer experience data comprising customer touchpoint data representative of one or more touchpoints of the associated customer with the system during the current service request.

In accordance with an embodiment, at step 1630, the method can provide a feature transformation application running at the data analytic environment and operatively coupled with the data store application, wherein the feature transformation application generates mappings of the customer touchpoint data representative of the one or more touchpoints of the associated customer with the system with customer sentiment data representative of an emotion of the customer at each of the one or more touchpoints.

In accordance with an embodiment, at step 1640, the method can provide a feature extraction and transformation application running at the data analytic environment and operatively coupled with the feature transformation application, wherein the feature extraction and transformation application translates the mappings to customer problem data representative of customer problems.

In accordance with an embodiment, at step 1650, the method can provide a predictive analytics application running at the data analytic environment and operatively coupled with the feature extraction and transformation application, wherein the predictive analytics application comprises one or more machine learning (ML) AI models trained based on one or more previous service request lifecycles of the associated customer to determine latent emotions of the associated customer that are detectable by the one or more ML AI models based on the customer problem data.

In accordance with an embodiment, at step 1660, the method can generate, by the predictive analytics application, a customer service prioritization signal indicative of a need to prioritize the current service request based on the determined latent emotions of the associated customer.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art. For example, although several of the examples provided herein illustrate use with cloud environments such as Oracle Analytics Cloud; in accordance with various embodiments, the systems and methods described herein can be used with other types of enterprise software applications, cloud environments, cloud services, cloud computing, or other computing environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for use with a data analytics environment to enable use of artificial intelligence (AI) in providing customer support, the comprising:
a computer including one or more processors, that provides access to a data analytics environment;
a data store application running at the data analytic environment, wherein the data store application is configured to obtain, during a lifecycle of a current service request received by the system from an associated customer and prior to an end of the lifecycle of the current service request, factual customer experience data comprising customer touchpoint data representative of one or more touchpoints of the associated customer with the system during the current service request;
a feature transformation application running at the data analytic environment and operatively coupled with the data store application, wherein the feature transformation application is configured to generate mappings of the customer touchpoint data representative of the one or more touchpoints of the associated customer with the system with customer sentiment data representative of an emotion of the customer at each of the one or more touchpoints;
a feature extraction and transformation application running at the data analytic environment and operatively coupled with the feature transformation application, wherein the feature extraction and transformation application is configured to translate the mappings to customer problem data representative of customer problems; and
a predictive analytics application running at the data analytic environment and operatively coupled with the feature extraction and transformation application, wherein the predictive analytics application comprises one or more machine learning (ML) AI models trained based on one or more previous service request lifecycles of the associated customer to determine latent emotions of the associated customer that are detectable by the one or more ML AI models based on the customer problem data, wherein the predictive analytics application is configured to selectively generate a customer service prioritization signal indicative of a need to prioritize the current service request based on the determined latent emotions of the associated customer.

2. The system according to claim 1, wherein:
the predictive analytics application is configured to selectively generate the customer service prioritization signal indicative of the need to prioritize the current service request during the lifecycle of the current service request and prior to the end of the lifecycle of the current service request.

3. The system according to claim 1, wherein:
the one or more machine learning AI models of the predictive analytics application are trained to determine a customer effort score (CES) related to the determined latent emotions of the associated customer; and
the one or more machine learning AI models of the predictive analytics application are configured to selectively generate the customer service prioritization signal based on a level of the determined CES relative to a predetermined escalation threshold CES of the associated customer.

4. The system according to claim 1, further comprising:
an agent user interface running at the data analytic environment and in operative communication with the predictive analytics application,
wherein the agent user interface is configured to render a proactive escalation management dashboard on a display device,
wherein the proactive escalation management dashboard comprises an image representation of the customer service prioritization signal for visual indication to an associated agent user of the system the need to prioritize the current service request based on the determined emotions of the associated customer.

5. The system according to claim 4, wherein:
the data store application is configured to obtain, during a plurality of lifecycles of current service requests received by the system from a plurality of associated customers and prior to ends of the plurality of lifecycles of the plurality of current service requests, factual customer experience data comprising customer touchpoint data representative of one or more touchpoints of each of the plurality of associated customers with the system during the plurality of current service requests;
the feature transformation application is configured to generate mappings of the plurality of customer touchpoint data representative of the one or more touchpoints of each of the plurality of associated customers with the system with customer sentiment data representative of an emotion of each of the plurality of customers at each of the one or more touchpoints;
the feature extraction and transformation application is configured to translate the mappings to the customer problem data representative of customer problems;
the one or more machine learning AI models of the predictive analytics application are trained based on one or more previous service request lifecycles of each of the plurality of associated customers to determine latent emotions of each of the plurality of associated customers based on the customer problem data;
the predictive analytics application is configured to selectively generate a plurality of customer service prioritization signals each being indicative of a need to prioritize the plurality of current service requests based on the determined latent emotions of each of the plurality of associated customers; and
the proactive escalation management dashboard comprises a plurality of image representations of the plurality of customer service prioritization signals providing visual indication to the associated agent user of the system the need to prioritize the plurality of current service requests based on the determined emotions of the plurality of associated customers, and providing a visual cue to the associated agent user of relative severity rankings between each of the plurality of current service requests whereby the associated agent user may selectively tend to a first current service request having a first severity ranking before tending to a second current service request having a second severity ranking less than the first severity ranking of the first service request.

6. The system according to claim 1, wherein:
the feature transformation application is configured to generate the mappings of the customer touchpoint data with the customer sentiment data as a dataset comprising a spreadsheet;
the feature extraction and transformation application is configured to receive the dataset and to translate the mappings to the customer problem data in a descriptive analytic language; and
the predictive analytics application is configured to receive the customer problem data translated to the descriptive analytic language and to selectively generate the customer service prioritization signal indicative of the need to prioritize the current service request based on the determined emotions of the associated customer.

7. The system according to claim 1, wherein:
the one or more machine learning AI models of the predictive analytics application comprise one or more of a trained neural network model, a trained classification and regression tree (CART) model, and/or a trained Naive Bayes model;
the predictive analytics application is configured to selectively generate the customer service prioritization signal using the one or more of the trained neural network model, the trained CART model, and/or the trained Naive Bayes model, wherein the generated customer service prioritization signal is indicative of the need to prioritize the current service request based on the determined latent emotions of the associated customer.

8. A method for use with a data analytics environment to enable use of artificial intelligence (AI) in providing customer support, the method comprising:
providing a computer including one or more processors, that provides access to a data analytics environment;
providing a data store application running at the data analytic environment, wherein the data store application obtains, during a lifecycle of a current service request received by the system from an associated customer and prior to an end of the lifecycle of the current service request, factual customer experience data comprising customer touchpoint data representative of one or more touchpoints of the associated customer with the system during the current service request;
providing a feature transformation application running at the data analytic environment and operatively coupled with the data store application, wherein the feature transformation application generates mappings of the customer touchpoint data representative of the one or more touchpoints of the associated customer with the system with customer sentiment data representative of an emotion of the customer at each of the one or more touchpoints;
providing a feature extraction and transformation application running at the data analytic environment and operatively coupled with the feature transformation application, wherein the feature extraction and transformation application translates the mappings to customer problem data representative of customer problems; and
providing a predictive analytics application running at the data analytic environment and operatively coupled with the feature extraction and transformation application, wherein the predictive analytics application comprises one or more machine learning (ML) AI models trained based on one or more previous service request lifecycles of the associated customer to determine latent emotions of the associated customer that are detectable by the one or more ML AI models based on the customer problem data, wherein the predictive analytics application generates a customer service prioritization signal indicative of a need to prioritize the current service request based on the determined latent emotions of the associated customer.

9. The method according to claim 8, wherein:
the predictive analytics application selectively generates the customer service prioritization signal indicative of the need to prioritize the current service request during the lifecycle of the current service request and prior to the end of the lifecycle of the current service request.

10. The method according to claim 8, wherein:
the one or more machine learning AI models of the predictive analytics application are trained to determine a customer effort score (CES) related to the determined latent emotions of the associated customer; and
the one or more machine learning AI models of the predictive analytics application selectively generate the customer service prioritization signal based on a level of the determined CES relative to a predetermined escalation threshold CES of the associated customer.

11. The method according to claim 8, further comprising:
providing an agent user interface running at the data analytic environment and in operative communication with the predictive analytics application,
wherein the agent user interface renders a proactive escalation management dashboard on a display device,
wherein the proactive escalation management dashboard comprises an image representation of the customer service prioritization signal for visual indication to an associated agent user of the system the need to prioritize the current service request based on the determined emotions of the associated customer.

12. The method according to claim 11, wherein:
the data store application operates to obtain, during a plurality of lifecycles of current service requests received by the system from a plurality of associated customers and prior to ends of the plurality of lifecycles of the plurality of current service requests, factual customer experience data comprising customer touchpoint data representative of one or more touchpoints of each of the plurality of associated customers with the system during the plurality of current service requests;
the feature transformation application operates to generate mappings of the plurality of customer touchpoint data representative of the one or more touchpoints of each of the plurality of associated customers with the system with customer sentiment data representative of an emotion of each of the plurality of customers at each of the one or more touchpoints;
the feature extraction and transformation application is configured to translate the mappings to the customer problem data representative of customer problems;
the one or more machine learning AI models of the predictive analytics application are trained based on one or more previous service request lifecycles of each of the plurality of associated customers to determine latent emotions of each of the plurality of associated customers based on the customer problem data;
the predictive analytics application operates to selectively generate a plurality of customer service prioritization signals each being indicative of a need to prioritize the plurality of current service requests based on the determined latent emotions of each of the plurality of associated customers; and
the proactive escalation management dashboard comprises a plurality of image representations of the plurality of customer service prioritization signals providing visual indication to the associated agent user of the system the need to prioritize the plurality of current service requests based on the determined emotions of the plurality of associated customers, and providing a visual cue to the associated agent user of relative severity rankings between each of the plurality of current service requests whereby the associated agent user may selectively tend to a first current service request having a first severity ranking before tending to a second current service request having a second severity ranking less than the first severity ranking of the first service request.

13. The method according to claim 8, wherein:
the feature transformation application operates to generate the mappings of the customer touchpoint data with the customer sentiment data as a dataset comprising a spreadsheet;
the feature extraction and transformation application operates to receive the dataset and to translate the mappings to the customer problem data in a descriptive analytic language; and
the predictive analytics application is configured to receive the customer problem data translated to the descriptive analytic language and to selectively generate the customer service prioritization signal indicative of the need to prioritize the current service request based on the determined emotions of the associated customer.

14. The method according to claim 8, wherein:
the one or more machine learning AI models of the predictive analytics application comprise one or more of a trained neural network model, a trained classification and regression tree (CART) model, and/or a trained Naive Bayes model;
the predictive analytics application operates to selectively generate the customer service prioritization signal using the one or more of the trained neural network model, the trained CART model, and/or the trained Naive Bayes model, wherein the generated customer service prioritization signal is indicative of the need to prioritize the current service request based on the determined latent emotions of the associated customer.

15. A non-transitory computer readable medium having instructions thereon for use with a data analytics environment to enable use of artificial intelligence (AI) in providing customer support for use with the data analytics environment, that when run and executed cause the computer to perform steps comprising:
providing a computer including one or more processors, that provides access to a data analytics environment;
providing a data store application running at the data analytic environment, wherein the data store application obtains, during a lifecycle of a current service request received by the system from an associated customer and prior to an end of the lifecycle of the current service request, factual customer experience data comprising customer touchpoint data representative of one or more touchpoints of the associated customer with the system during the current service request;
providing a feature transformation application running at the data analytic environment and operatively coupled with the data store application, wherein the feature transformation application generates mappings of the customer touchpoint data representative of the one or more touchpoints of the associated customer with the system with customer sentiment data representative of an emotion of the customer at each of the one or more touchpoints;
providing a feature extraction and transformation application running at the data analytic environment and operatively coupled with the feature transformation application, wherein the feature extraction and transformation application translates the mappings to customer problem data representative of customer problems; and
providing a predictive analytics application running at the data analytic environment and operatively coupled with the feature extraction and transformation application, wherein the predictive analytics application comprises one or more machine learning (ML) AI models trained based on one or more previous service request lifecycles of the associated customer to determine latent emotions of the associated customer that are detectable by the one or more ML AI models based on the customer problem data, wherein the predictive analytics application generates a customer service prioritization signal indicative of a need to prioritize the current service request based on the determined latent emotions of the associated customer.

16. The non-transitory computer readable medium according to claim 15, wherein the instructions thereon when run and executed cause the computer to perform further steps comprising:
selectively generating, by the predictive analytics application, the customer service prioritization signal indicative of the need to prioritize the current service request during the lifecycle of the current service request and prior to the end of the lifecycle of the current service request.

17. The non-transitory computer readable medium according to claim 15, wherein the instructions thereon when run and executed cause the computer to perform further steps comprising:
providing the one or more machine learning AI models of the predictive analytics application to determine a customer effort score (CES) related to the determined latent emotions of the associated customer; and
selectively generating, by the one or more machine learning AI models of the predictive analytics application, the customer service prioritization signal based on a level of the determined CES relative to a predetermined escalation threshold CES of the associated customer.

18. The non-transitory computer readable medium according to claim 15, wherein the instructions thereon when run and executed cause the computer to perform further steps comprising:
providing an agent user interface running at the data analytic environment and in operative communication with the predictive analytics application; and
rendering, by the agent user interface, a proactive escalation management dashboard on a display device,
wherein the proactive escalation management dashboard comprises an image representation of the customer service prioritization signal for visual indication to an associated agent user of the system the need to prioritize the current service request based on the determined emotions of the associated customer.

19. The non-transitory computer readable medium according to claim 15, wherein the instructions thereon when run and executed cause the computer to perform further steps comprising:
generating, by the feature transformation application, the mappings of the customer touchpoint data with the customer sentiment data as a dataset comprising a spreadsheet;
receiving, by the feature extraction and transformation application, the dataset and to translate the mappings to the customer problem data in a descriptive analytic language; and
receiving, by the predictive analytics application, the customer problem data translated to the descriptive analytic language and selectively generating the customer service prioritization signal indicative of the need to prioritize the current service request based on the determined emotions of the associated customer.

20. The non-transitory computer readable medium according to claim 15, wherein the instructions thereon when run and executed cause the computer to perform further steps comprising:
providing the one or more machine learning AI models of the predictive analytics application comprising one or more of a trained neural network model, a trained classification and regression tree (CART) model, and/or a trained Naive Bayes model; and
selectively generating, by the predictive analytics application, the customer service prioritization signal using the one or more of the trained neural network model, the trained CART model, and/or the trained Naive Bayes model, wherein the generated customer service prioritization signal is indicative of the need to prioritize the current service request based on the determined latent emotions of the associated customer.
